(19) United States
(12) Patent Application Publication
(10) Pub. No.: US 2011/0137657 A1
(43) Pub. Date: Jun. 9, 2011

(54) KITCHEN AND/OR DOMESTIC APPLIANCE

(75) Inventors: Claudio Cenedese, Pasian di Prato (IT); Dragan Raus, Pordenone (IT); Omero Tuzzi, Udine (IT); Maurizio Ugel, Pordenone (IT); Ennio Pippia, San Giorgio Di Nogaro (IT)

(73) Assignee: ELECTROLUX PROFESSIONAL SPA, Pordenone (IT)

(21) Appl. No.: 12/962,900

(22) Filed: Dec. 8, 2010

Related U.S. Application Data
(63) Continuation of application No. 10/468,514, filed on Jan. 21, 2004, now abandoned.

(30) Foreign Application Priority Data
Feb. 23, 2001 (IT) PN2001A000017

(51) Int. Cl. G10L 15/00

(52) U.S. Cl. 704/275; 704/E15.001

(57) ABSTRACT

The invention relates to a kitchen and/or domestic appliance comprising input means, which are connected to a voice-recognition system, for acoustic operator commands. The invention is characterised in that means for executing command-dependent actions are provided and that the voice-recognition system is used to identify and check the authorisation of a user.

The invention concerns a kitchen and/or household appliance, by which can be understood major household appliances, in particular, for use in kitchens of large-scale catering establishments or restaurants.

As technology advances, these appliances continue to be constantly developed by improving specific details. Due to the rapid development of electronics and computer technology in the last few years, the need has arisen to apply new technologies in kitchen and/or household appliances to facilitate their operation and to increase user convenience. The necessity of manually executing all of the operating procedures is viewed as a major disadvantage.

It is therefore an object of the invention to avoid the aforementioned disadvantages and to ensure that the operation of a kitchen and/or household appliance is simpler and more ergonomically configured.

To solve this problem, a kitchen and/or household appliance according to the invention is provided with an input device connected to a voice recognition system for acoustic operator commands, wherein a device is provided for carrying out the command-dependent actions.

Operating procedures that were undertaken manually until now can be executed by voice operation in the kitchen and/or household appliance. It frequently occurs that the appliance doors or flaps must be opened or closed to place objects into or remove objects from the appliance. Considerable facilitation of this activity results if the opening or closing procedure is instead carried out automatically by voice input of the user. In this way, the bothersome requirement of putting down the objects in order to open the door manually is eliminated.

A considerable increase in overall efficiency can be achieved. The devices can be turned on or off in the same way by inputting the operating parameters required via operator commands. In any case, a corresponding device for carrying out the given command is provided. This device can be, for example, an automatic door opener or a cooling or heating source for a temperature change or the like.

The kitchen and/or household appliance of the invention is suitably equipped with a voice recognition system. Its main task consists in the evaluation of the voice data by converting the received tone data into executable operating commands.

A further development of the invention provides configuration of the voice recognition system for the identification of a user for security reasons. Given a user's speech patterns, user-specific characteristics can be derived, based on which each user can be clearly identified. An especially high security level can be achieved if the voice recognition system is configured for carrying out an authorization check. This authorization check is suitably conducted after a user has been identified and the entered command is or is not carried out, depending upon the results of the authorization check. Different privileges can be granted if there are several users, to ensure that all the actions are initiated only by authorized users.

The kitchen and/or household appliance is particularly suitable for use in the professional field, for example, in the kitchen of large-scale catering establishment or restaurant. Due to the multitude of appliances that are operated, the ambient noise can be disruptive for recognition of voice data. It has been discovered that it is particularly advantageous to configure the input device as a radio microphone that coacts with a receiver arranged in the kitchen and/or on the household appliance.

A display, which is preferably configured as a flat screen, is provided for the operator to output data. The known devices generally have only one numerical display, for example, to display temperatures, times, or programs. Far greater presentation flexibility is achieved with a display screen. Aside from the purely numerical data, texts, images, diagrams or films can be displayed that can represent important data for the user. The operating instructions of the appliance, for example, can be shown on the display.

Particularly efficient are screens that are sensitive to touch, called “touch screens.” A separate input keyboard can be omitted on such screens; in addition, extremely flexible input menus can be displayed on the screen.

For reasons of compatibility, providing the kitchen and/or household appliance with a computing unit configured preferably as a personal computer is recommended. Highly developed PC technology can be obtained at relatively low costs. In addition, a large number of input and output devices are available that can be connected to a PC.

The kitchen and/or household appliance can also have a printing device for outputting printed data. It is understood that other bulk memories, for example, CD-ROM drives, diskette drives, hard drives, or card readers are also available.

The invention is suitable in particular for a refrigerator or freezer or convection oven or combination oven or a range or a dishwasher or a washing machine. With kitchen equipment in the form of a refrigerator or freezer, a device for recording the groceries that are removed and/or stored can be provided. The equipment can be in the form of a reading device for foods provided with readable identification. Until now, groceries were primarily marked with bar codes wherein their information content was recorded and which were read via a laser scanner integrated into the device. It is conceivable that in the future the groceries or their packaging could be provided with small transponders. These are electronic circuits that transmit specific data upon request via the reading device. The data transmission takes place by radio; for this purpose, each transponder as well as also the reading device must be equipped with an antenna. In a unique kitchen appliance, for example, several reception antennas can be arranged in a refrigerator, which are connected to a common reading device and can be selectively requested via a multiplexer.

In an advantageous design of the invention, a multitude of different data concerning the content of the kitchen appliance can be scanned by the user. For example, the total contents can be listed. They can then automatically indicate which foods are close to exceeding or have already exceeded their expiration date. The total weight and the price of the products can be displayed. It is also possible to indicate whether a minimum number or a minimum quantity of one specific foodstuff is not reached; an order is immediately printed automatically or the reorder procedure is initiated. One or several menu suggestions can be prepared based on the inventory.

An enormous expansion of the utilization field results if the kitchen and/or household appliance has a means of transmitting data to an external computing device. Thus, for example, all of the kitchen and/or household appliances in a large-scale catering establishment can be monitored and controlled via a central control. The data transmission device can also be configured as a modem, so that the data transmission takes place via a telephone line, a mobile radio connection, or a computer network. The Internet can also be used as a link between computers and for data exchange. It is suggested to control or to remote-control the kitchen and/or household device according to the invention via an external computer.

In many cases it is desirable to allow access to an appliance only to specific workers. This can be advantageous for reasons of security. A few appliances also require intensive training to prevent faulty operation; therefore, an access control system can effectively prevent operation of the appliances by unauthorized persons.

The access control system can be configured in the simplest form as a mechanical lock in the kitchen and/or household appliance of the invention. It can also be configured alternatively as a card reader, so that the access is only granted after inserting a coded card. As an alternative, input of an alphanumerical access code can be required, which is comparable to a stored code.

For additional access security, it can be designed so that the access control system is configured for checking a biometric parameter. Systems that record a fingerprint or the human eye are especially well developed. The human voice can also be utilized as a biometric parameter. Use of such a device is conceivable, for example, if special medications that can only be dispensed to specific persons are stored in the refrigerator.

Other advantages, features, and details of the invention result from the exemplary designs described below, wherein:

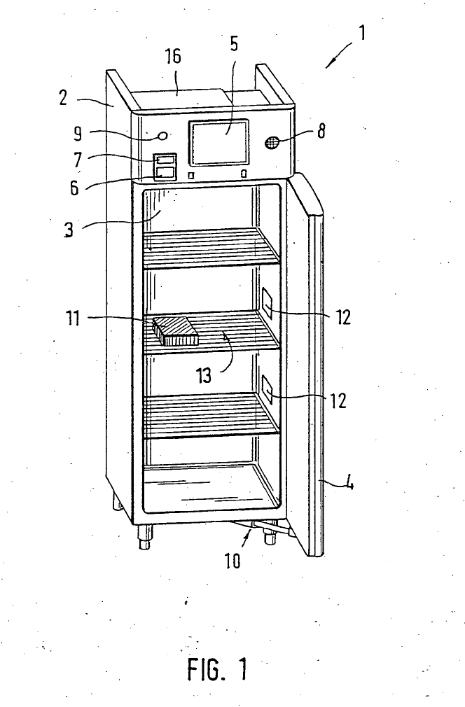

FIG. 1 shows a kitchen appliance configured as a refrigerator with a screen and input device for operator commands, and

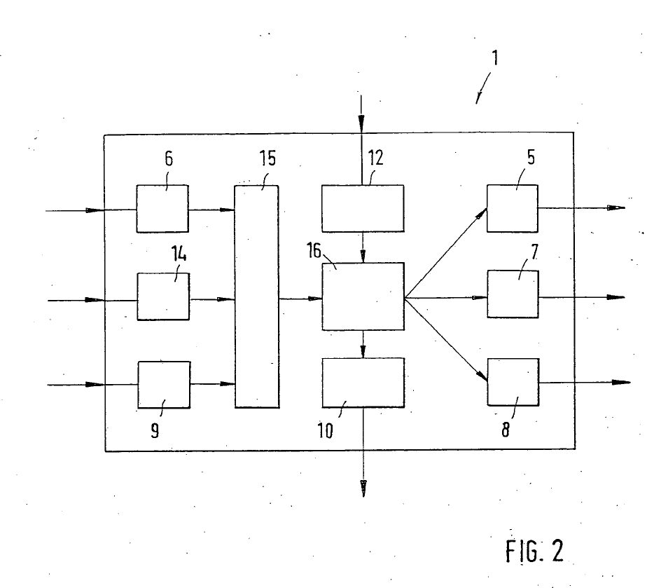

FIG. 2 shows a schematic depiction of the refrigerator shown in FIG. 1 in the form of a diagram.

The refrigerator 1 consists of a housing 2 and an interior space 3 for storing groceries. The refrigerator 1 is closed with the refrigerator door 4.

A screen 5 is integrated in the housing 2 in the front side of the refrigerator 1. It is a flat screen provided on its surface with a touch screen layer, so that user operator commands can be entered by touching the screen 5. The refrigerator 1 has an input device configured as a microphone 6 for operator commands. Over the microphone 6 is located a printer 7, with which the data of the stored groceries or appliance data or operation parameters can be printed. Next to the screen 5, a loudspeaker 8 is located, which is connected to a voice output system. A reading device for fingerprints is also located in the front plate of the refrigerator 1. A central computer 16 is located within the housing 2.

If a user would like to remove groceries from the refrigerator 1, it is sufficient to give the operator command “open,” which is received by the refrigerator 1 via the microphone 6 that serves as input device. This spoken operator command is processed by analyzing the tone sequence and comparing the same to predetermined patterns, so that the desired command of the user can be ascertained. Voice recognition systems such as these have become highly developed in the interim and can be obtained as chip components. The operator commands can, of course, be entered in different languages. The voice recognition system 15 can filter out the disruptive background noises or echoes.

If the refrigerator 1 is in a kitchen of a large-scale catering establishment, reciprocal influences could occur if several kitchen appliances with a voice recognition system are installed in one room. For this reason, the users wear portable microphones that transmit the data by radio to the refrigerator 1. A reception antenna 14 is located inside the refrigerator 1, which is not depicted in FIG. 1 that receives the radio signals and forwards them to the voice recognition system 15. If there are several appliances, one particular appliance can be selected if the operator pronounces the appliance number of the corresponding appliance. The device that is located in the vicinity of the operator can also be selected the device, since this is the one that normally receives the strongest radio signals.

After the operator command has been received and recognized, a specific action can be initiated that is dependent upon the voice information. The door 4 of the refrigerator 1, for example, can be opened or closed automatically. In this way, a particular ergonomic handling results and an operator can place a tray in the refrigerator 1 without having to previously put the same down. A door drive 10 is arranged for this purpose on the door 4, which is controlled by the operator command.

The automatic door opening system makes it possible to control the opening and closing of the door 4 via the refrigerator 1. Due to security reasons, the door 4 remains closed if a command was not correctly recognized or if a user does not have the authorization for the command. The door 4 can be automatically closed after a specific opening time. In this way, a hermetic closure of the interior space 3 is achieved that maintains the desired temperature. If there is a blackout, the door 4 is automatically closed, but can then be opened manually.

User identification can also be conducted by means of the voice recognition system 15. The human voice contains individual characteristic features that can be determined by electronic signal processing. Similar to a fingerprint, voice and speech have features that are unique to an individual, based on which the identification of a user is possible. For this purpose, the linguistic features must be recorded and recognized once by the voice recognition system 15 in order to recognize a user in the future based on his/her voice.

After the user is identified, his authorization for use of the corresponding operator command is checked. It is thereby possible to grant different authorizations to different users. It offers the possibility that each user can place and again remove groceries in or from the refrigerator 1. Only selected users are entitled to reorder groceries. An authorization check can be carried out once a day; as an alternative, the authorization can also be checked before carrying out each operator command.

Aside from the voice recognition system 15, the refrigerator 1 also comprises a voice response system, in which voice data can be directed to the user via the loudspeaker 8. Appliance data such as temperatures, a specific appliance content, warning indications, or error reports can be displayed. These voice data are generated via a voice synthesizer and have the advantage that they are also noticed by the user if he/she is not paying attention to the appliance. In comparison to the small displays, the voice data are also considerably easier to understand. Rapid interactive communication between the operator and the appliance is possible via the voice recognition and voice response system. Based on operator's authorization confirmation, the appliance determines whether the corresponding command is being carried out. The operator can inquire and acoustically output a multitude of appliance data. He/she can inquire, for example, on the exact content of the refrigerator 1 or the product weight.

The acoustic data can be supported by optical data that are displayed on the screen 5. The data can also be displayed on the flat screen 5 in larger print, which can be perceived even at a specific distance from the refrigerator 1. It is therefore unnecessary for the operator to be in the immediate vicinity of the refrigerator 1, but a quick glance is sufficient if the operator is involved in another activity. All the data can be displayed on the screen 5 and can be printed by the printer 7. Thus, if a minimum number of a specific foodstuff is short, a reorder list can be printed automatically.

Various groceries 11 are located in the interior space 3 of the refrigerator 1 whose packaging is marked for identification with a so-called “tag.” This tag is an integrated circuit in the form of a chip, which has a small integral antenna. The chip contains specific data, for example, an identification number or data about the corresponding products that can be read by an external reading device. To select these data, different antennas 12 are arranged on the inner wall of the refrigerator 1, which transmit a radio wave that is received by the tag. As a consequence, the tags transmit their stored data to the reading device. The signals are processed by the reading device and forwarded to the computer 16. In this way, it is always known which groceries are located inside the refrigerator 1 and in which quantities. The tags can therefore replace the previously used bar codes. An option exists to provide each drawer 13 of the refrigerator 1 its own antenna 12 for this purpose. The different antennas 12 can be selectively scanned via the multiplexer. A list of the products stored in the refrigerator 1 can be requested at any time with these data. Products for which the expiration date is near or has already been exceeded can be determined automatically. In addition, the nutritional value of the individual products can be determined automatically. If individual products are missing, the system can automatically display a notification to the operator. All these events are recorded internally; the individual operator commands and the activities of the user can also be recorded. It is also possible to prepare menu suggestions automatically based on the stored products in the refrigerator, which can be displayed on the screen or can be printed.

The refrigerator 1 is connected to an external network via the mobile radio connection (which is not shown in FIG. 1). In this way, error notifications or alarm signals can be transmitted to the external computing device. It is also possible to produce a connection to the external computer for purposes of service and maintenance to eliminate errors. If there are problems, a user can also receive the support from the manufacturer or customer service via the radio connection. Customer service can undertake an online diagnosis via the radio connection and replacement parts can be ordered. Software upgrades can also be conducted in this way without necessitating the use of an on-site technician.

The refrigerator 1 is equipped with an access control system for security reasons. The reading device 9 in the exemplary design serves to recognize fingerprints. In a similar way, the physical outlay of the hand, the face, the iris, or the cornea can serve as biometric parameters. Further possible biometric parameters are the shape of the ears, the voice, or the physical outlay of the finger. Based on a biometric parameter, access control ensures greater security than the conventional systems such as keys, cards, or the use of secret numbers. Voice recognition and fingerprint checks are preferred.

The schematic structure of the refrigerator 1 can be seen in FIG. 2. The refrigerator 1 has a series of input device for operator commands, which are the microphone 6, the receiver 14 for radio signals, and the reader 9 for fingerprints. The external data reach the refrigerator 1 via these input devices. The optical and acoustic input signals are processed by the recognition system 15, so that an authorization check is possible. The recognition system 15 is connected to the central computer 16. The door drive 10 is controlled by the computer 16; adjustments can also be carried out on the refrigerator 1, for example, the temperature selection, etc. The computer 16 can be connected to an external computer via a radio connection for data transmission.

The radio signals emitted by the tags on the groceries are received by the antenna 12 and transmitted to the computer 16.

Several output devices are connected to the computer 16 for outputting data to the user. The data are displayed on the screen 5 or are directed to the printer 7. Acoustic outputs take place via the loudspeaker 8.

1. A kitchen or household appliance, comprising a housing and a door and having an interior space in which groceries can be stored or from which groceries can be again removed, and comprising devices for recording the removed or stored groceries and further devices for carrying out command-dependent actions, wherein the refrigerator includes an input device for acoustic operator commands connected to a voice recognition system, wherein a device for data transmission to an external computer is provided, and wherein the appliance can be remotely controlled via the external computing device.

2. The kitchen or household appliance of claim 1, wherein data about the stored groceries can be inquired or printed.

3. The kitchen or household appliance of claim 2, wherein an indication as to an impending or already occurred lapse of the expiration date of a product can be issued automatically based on a command triggered by a control program or if required based on an inquiry command of an operator.

4. The kitchen or household appliance of claim 1, wherein an indication as to an impending or already occurred lapse of the expiration date of a product can be issued automatically based on a command triggered by a control program or if required based on an inquiry command of an operator.

5. The kitchen or household appliance of claim 1, wherein the device for recording the removed or stored groceries is configured in order to initiate a reorder procedure when a minimum number or minimum quantity of groceries is not met.

6. The kitchen or household appliance of claim 1, wherein the device for recording removed or stored groceries is configured as a reading device for groceries provided with a readable identification device.

7. The kitchen or household appliance of claim 6, wherein the reading device is configured or registering bar codes or for reading transponders.

8. The kitchen or household appliance of claim 7, wherein the reading device comprises at least one reception antenna for transponder signals.

9. The kitchen or household appliance of claim 7, wherein the reading device has several reception antennas that can be scanned via a multiplexer.

10. The kitchen or household appliance of claim 8, wherein there are several insertion or storage levels to each of which a separate reception antenna is provided.

11. The kitchen or household appliance of claim 8, wherein a control or control device is provided which accepts the signals received by the reception antenna and which processes the information content of the signal.

12. (canceled)

13. The kitchen or household appliance of claim 12, wherein the device consists of a modem or a GSM modem or a LAN connection.

14. The kitchen or household appliance of claim 12, wherein the data transmission takes place via a computer network or via the Internet.

15. (canceled)

16. The kitchen or household appliance of claim 12, wherein the appliance can be used as Internet terminal.

17. The kitchen or household appliance of claim 1, wherein the appliance has a display configured as a screen, preferably a flat screen.

18. The kitchen or household appliance of claim 17, wherein the screen is configured as a touch screen for inputting operator commands.

19. The kitchen or household appliance of claim 17, wherein the screen is arranged on the front of the appliance in a raised position or on or in an appliance door.

20. The kitchen or household appliance of claim 1, wherein the appliance has a computing device configured preferably as a personal computer, which is connected to the input device and, if required, to the output device.

21. The kitchen or household appliance of claim 1, wherein the voice recognition system is configured for the identification of a user.

22. The kitchen or household appliance of claim 1, wherein the voice recognition system is configured for carrying out an authorization check of a user.

23. The kitchen or household appliance of claim 1, wherein the input device is configured as a radio microphone, which coacts with a receiver arranged or on or in the kitchen or household appliance.

24. The kitchen or household appliance of claim 1, wherein the appliance has a voice recognition system.

25. The kitchen or household appliance of claim 1, wherein the opening or closing of the appliance door or flap can be controlled via an operator command.

26. The kitchen or household appliance of claim 25, wherein the appliance door or flap is configured so as to automatically close after a specific opening time.

27. The kitchen or household appliance of claim 1, wherein the appliance has a printing device.

28. The kitchen or household appliance of claim 1, wherein the appliance has an access control system.

29. The kitchen or household appliance of claim 28, wherein the access control system is configured as a mechanical lock or as a card reader.

30. The kitchen or household appliance of claim 28, wherein the access control system is configured for inputting a numerical or alphanumerical code and the access is granted if said code coincides with a stored code.

31. The kitchen or household appliance of claim 28, wherein the access control system is configured for checking a biometric parameter.

32. The kitchen or household appliance of claim 31, wherein the access control system has a device for recording a fingerprint.
